(19) United States
(12) Patent Application Publication
(10) Pub. No.: US 2025/0045331 A1
(43) Pub. Date: Feb. 6, 2025

(54) INCREMENTAL REBALANCING OF IN-MEMORY DISTRIBUTED GRAPHS FOR ELASTICITY, PERFORMANCE, AND SCALABILITY

(71) Applicant: Oracle International Corporation, Redwood Shores, CA (US)

(72) Inventors: ARNAUD DELAMARE, Zurich (CH); GIORGOS XANTHAKIS, Redwood City, CA (US); VASILEIOS TRIGONAKIS, Zurich (CH); SUNGPACK HONG, Palo Alto, CA (US); HASSAN CHAFI, San Mateo, CA (US); JINSU LEE, San Mateo, CA (US)

(21) Appl. No.: 18/228,487

(22) Filed: Jul. 31, 2023

(51) Int. Cl. G06F 16/901; G06F 9/455; G06F 9/50

(52) U.S. Cl. CPC G06F 16/9024; G06F 9/45558; G06F 9/5016; G06F 9/5083; G06F 2009/45562; G06F 2009/4557; G06F 2009/45583; G06F 2209/503; G06F 2209/505

(57) ABSTRACT

A graph rebalancing approach is provided that allows a distributed graph system to effectively support elasticity by incrementally balancing distributed in-memory graphs uniformly or in a custom manner on a set of given machines. Performing the incremental rebalancing operation comprises selecting a chunk in a source machine in the cluster having a surplus of chunks, selecting a target machine in the cluster having a deficit of chunks, transferring the selected chunk from the source machine to the target machine, and updating metadata in each machine in the cluster to reflect a location of the graph data elements in the selected chunk in the target machine.

### FIELD OF THE INVENTION

The present invention relates to distributed graph systems and, more particularly, to incremental rebalancing of in-memory distributed graphs for elasticity, performance, and scalability.

### BACKGROUND

A graph database is a database that uses graph structures for semantic queries with nodes, edges, and properties to represent and store data. A graph relates data items in the store to a collection of nodes and edges, the edges representing the relationships between the nodes. The relationships allow data in the store to be linked together directly and, in many cases, retrieved with one operation. Graph databases hold the relationships between data as a priority. The underlying storage mechanism of graph databases can vary. Relationships are a first-class citizen in a graph database and can be labeled, directed, or given properties. Some implementations use a relational engine and store the graph data in a table.

Many applications of graph database processing involve processing increasingly large graphs that do not fit in a single machine's memory. Distributed graph processing engines partition the graph among multiple machines and execute graph processing operations in the multiple machines, potentially in parallel, with communication of intermediate results between machines. Distributed graph processing engines can be implemented in cloud environments to provide dynamic scalability as graph sizes increase.

One of the key characteristics of cloud environments is elasticity: cloud environments provide resources that are available to be deployed on-demand when needed and stopped when not needed. Thus, resources can scale to the current demand. This elasticity is not only useful for ensuring well performing applications but can also significantly help to reduce the cost of such solutions. However, with distributed graph processing engines, graph data elements are distributed among a cluster of machines at the time of loading the graph, and scaling the cluster up or down by adding or removing machines creates imbalances among the machines, thus creating configurations that are suboptimal. For instance, scaling up the cluster by adding a machine creates an imbalance between the machines that were originally present and the added machine.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section. Further, it should not be assumed that any of the approaches described in this section are well-understood, routine, or conventional merely by virtue of their inclusion in this section.

### BRIEF DESCRIPTION OF THE DRAWINGS

In the drawings:

FIG. 1 is a block diagram illustrating an example of adding a machine to a cluster of machines executing a distributed graph processing engine in accordance with an illustrative embodiment.

FIG. 2A is a block diagram illustrating loading graph data into a cluster of machines that has been scaled up to include a new machine in accordance with an illustrated embodiment.

FIG. 2B is a block diagram illustrating distribution of data in a cluster of machines after graph data has been deleted from machines in accordance with an illustrated embodiment.

FIG. 3 is a flowchart illustrating rebalancing of graph data among machines in a cluster in accordance with an illustrative embodiment.

FIG. 4A shows an example of a vertex table in accordance with an illustrative embodiment.

FIG. 4B shows an example of edge data structures with properties in accordance with an illustrative embodiment.

FIG. 5 is a block diagram illustrating the data structures for a history of graphs in accordance with an illustrative embodiment.

FIG. 6 is a flowchart illustrating high level operation of rebalancing before starting transmission of data in accordance with an illustrative embodiment.

FIG. 7 depicts example distributions of chunks across four machines for which Equivalent Chunks ranking may be calculated in accordance with an illustrative embodiment.

FIG. 8 illustrates an example of a simple policy for selecting a target machine in accordance with an illustrative embodiment.

FIG. 9A illustrates an example of selecting a target machine with no provider metadata update in accordance with an illustrative embodiment.

FIG. 9B illustrates an example of selecting a target machine with provider metadata update after putting a chunk in the batch in accordance with an illustrative embodiment.

FIG. 10 is a flowchart illustrating chunk transmission in accordance with an illustrative embodiment.

FIG. 11 is a flowchart illustrating sending and receiving a chunk in accordance with an illustrative embodiment.

FIG. 12A depicts chunk transfer resulting in data duplication in accordance with an illustrative embodiment.

FIG. 12B depicts chunk transfer with physical array de-duplication in accordance with an illustrative embodiment.

FIG. 13A illustrates placement of graph data on a cluster of machines according to a default policy to bring graphs into a balance in accordance with an illustrative embodiment.

FIG. 13B illustrates placement of graph data on a cluster of machines according to explicit graph placement scheduling in accordance with an illustrative embodiment.

FIG. 14 is an example table illustrating per-machine weights for each graph in accordance with an illustrative embodiment.

FIG. 15 is a block diagram that illustrates a computer system upon which an embodiment of the invention may be implemented.

FIG. 16 is a block diagram of a basic software system that may be employed for controlling the operation of a computer system upon which an embodiment of the invention may be implemented.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### General Overview

Distributed graph processing enables the analysis of very large-scale graphs. Cloud environments provide the ability to dynamically increase or reduce the number of machines used by the cluster on which the distributed graph processing engine executes, in order to reduce hardware costs and to support computation spikes. The illustrative embodiments provide a graph rebalancing approach that allows a distributed graph system to effectively support elasticity by incrementally balancing distributed in-memory graphs uniformly (or in a custom manner) on a set of given machines, while also supporting non-uniform clusters. Rebalancing is lightweight and can be implemented in a way that operates in parallel with certain graph analytics. The presented graph rebalancing approach enables graph systems to both add new machines to and remove machines from the distributed graph cluster, while taking full advantage of hardware, thus improving performance.

The illustrative embodiments provide an approach for rebalancing in-memory distributed graphs to support elasticity in distributed graph systems. Rebalancing uses stable policies (but can be instructed by an external scheduler/placement manager to use any graph placement), is low-memory and incremental, and supports adding machines, removing machines, modifying the hardware limits at runtime of existing machines, as well as balancing graphs on heterogeneous hardware. Rebalancing can be configured on how aggressively it operates, allowing control of resource consumption and rebalancing speed. Furthermore, the rebalancing mechanism of the illustrative embodiments can, under certain implementations, be run during analytics executions and not simply in between user commands, which makes it a fully incremental background process. Finally, the rebalancing mechanism can leverage the fact that the graph processing system might perform periodic backups of its data on shared persistent storage (e.g., NFS or object store), in order to rebalance data without explicit serialization. The data still must be serialized to disk but without the need to perform direct network transfers. Rebalancing is configurable to allow one to choose between speed of user commands versus speed of rebalancing.

Graphs eventually become uniform across the set of machines of the distributed system, taking full advantage of the cluster. Additionally, with the same solution, the described design supports moving data out of existing machines. The rebalancing approach of the illustrative embodiments can move data either over message passing or store them to a shared filesystem (e.g., NFS, HDFS) or cloud object store. Furthermore, the low-overhead incremental approach enables always on rebalancing to enable leveraging hardware to the most.

Graph rebalancing does not perform graph partitioning, therefore, after many rebalancing data transfers over time, the original partitioning might deteriorate. However, the vertices and edges always stay together by design. Additionally, partitioning-aware selection of data portions to transfer helps alleviate this issue.

### Problem Description

Distributed graph processing enables the analysis of very large-scale graphs but comes at the potential cost of expensive hardware due to the very heavy in-memory computations that graph processing requires. For best performance and memory utilization, the graph data is split among the machines of the cluster and is not directly fully accessible by every machine. Additionally, most real-life data analysis services operate in phases, with some phases of heavy usage (either due to many users or because of some heavy batch computations, such as execution clustering analysis or PageRank on large graphs) and other phases with low utilization. To reduce hardware costs while supporting these usage spikes, distributed graph systems rely on elasticity, i.e., the ability to dynamically increase or reduce the number of machines used by the cluster of the runtime engine.

However, once one or more machines are added to a distributed cluster (similarly when a machine is removed), the preexisting graphs in the system do not have any presence on those machines, as they have already been partitioned on the previous condition of the cluster. FIG. 1 is a block diagram illustrating an example of adding a machine to a cluster of machines executing a distributed graph processing engine in accordance with an illustrative embodiment. As seen in FIG. 1, a graph is loaded into Machine 0 110 and Machine 1 120, and a new machine, Machine 2 130 is added to the cluster. This situation means that Machine 2 130 is part of the distributed graph cluster but holds no graph data and, thus, cannot really contribute to execution of graph computations, such as graph queries and algorithms. In other words, the distributed engine can onboard more machines with elasticity, but those new machines are either underutilized or not used at all.

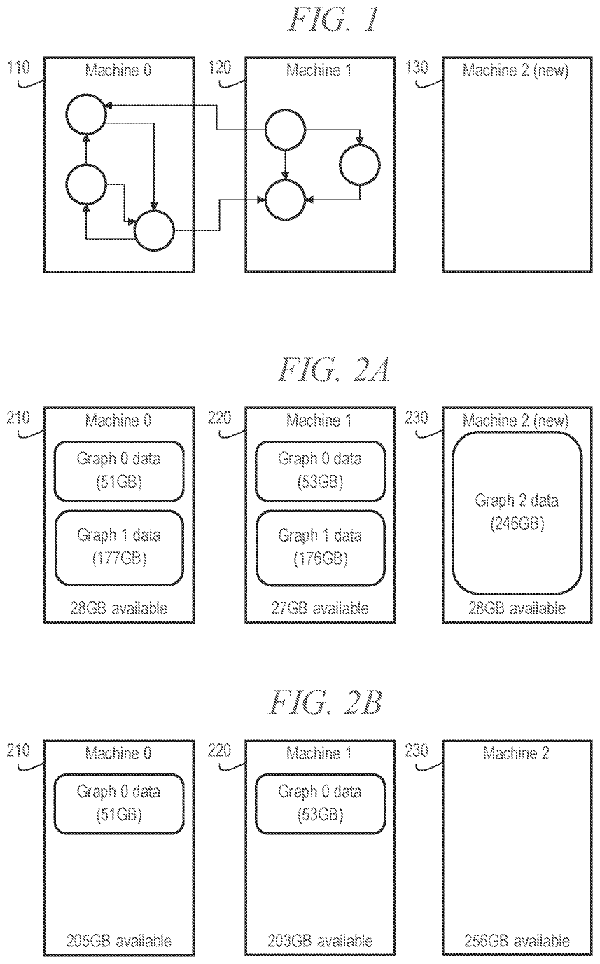

FIG. 2A is a block diagram illustrating loading graph data into a cluster of machines that has been scaled up to include a new machine in accordance with an illustrated embodiment. As seen in FIG. 2A, Graph 0 data and Graph 1 data are distributed between Machine 0 210 and Machine 1 220 fairly evenly. Newly loaded Graph 2 data in the system could possibly put data on the new Machine 2 230, but preexisting graphs are limited to the smaller set of machines, leading to possible execution scenarios where Graph 0 and Graph 1 were loaded before Machine 2 230 joined the cluster and are well partitioned on Machine 0 210 and Machine 1 220, but Graph 2 was loaded after Machine 2 230 joined the cluster (in many systems Machine 2 230 could have been added to actually enable the loading of Graph 2, if Machines 0 and 1 had no available space left). Such a placement of graph data to machines is in most cases very inefficient: graph computations on Graphs 0 and 1 will not use Machine 2 230, while computations on Graph 2 will only use Machine 2 230. Overall, such a placement will almost certainly lead to hardware underutilization, plus, it entails that elasticity cannot be used to speed up the computations on any already loaded graph (i.e., Graphs 0 and 1 in our example).

One solution would be to repartition any existing graph on all three machines, similar to how the initial loading of the graph happened on the two machines. However, graph partitioning is computationally intensive, cannot happen incrementally, and can easily end up fully replicating the graph, thus doubling the memory consumption until the graph is ready on all three machines. In the example shown in FIG. 2A, the three machines do not have enough memory to support such an operation, as they do not have enough available memory. Therefore, a more incremental low-memory reshuffling approach is needed, that would allow the graph to incrementally move data from Machine 0 210 and Machine 1 220 to Machine 2 230 and vice versa.

Once such a more incremental reshuffling mechanism is in place (i.e., we have answered the question of “how to move data of a graph from one machine to another”), the distributed graph engine may take care that the end result of reshuffling brings good performance and that it is stable, i.e., no graph is forever in reshuffling state.

The example of FIG. 2A demonstrates the problem of adding new machines to support faster and/or larger graph computations. However, there are scenarios where the system becomes underutilized, and it is the most efficient to shrink the deployment. FIG. 2B is a block diagram illustrating distribution of data in a cluster of machines after graph data has been deleted from machines in accordance with an illustrated embodiment. In the previous example in FIG. 2A, in case Graphs 1 and 2 are deleted by their corresponding owners, the distribution of graph data will be as shown in FIG. 2B. This distribution of graph data can be very resource wasteful. In such cases, the distributed graph cluster (or the control plane managing it), might decide to shrink the cluster to a single machine, as it easily fits the one remaining graph. To enable such functionality, the graph system should be able to move data from an existing machine to others to support removing machines from the distributed cluster, e.g., moving all Graph 0 data from Machine 1 220 to Machine 0 210 and remove both Machine 1 220 and Machine 2 230.

### Incremental Rebalancing of In-Memory Distributed Graphs

The illustrative embodiments introduce an incremental, low-memory approach to rebalancing in-memory distributed graphs that includes simple stable policies that can be used in the presence of elasticity, both for adding and removing machines from the distributed graph engine cluster. The approach assumes that the graph is split into medium size (e.g., few 100 s of MB) chunks of similar memory size that can be serialized and deserialized for transferring from one machine to another. The content of each chunk is described in more detail below. One approach to achieve this partitioning of the graph is by instructing the loading infrastructure to operate as if there were many more machines than the actual number of machines. The number of such “virtual machines” (i.e., the number of chunks) can be dynamically configured based on the expected cluster size and the estimated graph size to achieve a good balance between number of chunks and size per chunk.

The design of the rebalancing approach aims at distributing an in-memory graph across a set of machines so that every machine has almost the same number of chunks as the others. This is a simple yet effective policy: adding a new machine to the cluster means extending the set of machines with the new machine, while removing a machine involves removing it from the set of machines for rebalancing a graph. To enable further flexibility, instead of just a set of machines, one can use a map of machines that points to per-machine weights that are respected when rebalancing. These per-machine weights enable heterogeneous machines with respect to their memory and/or compute capacity—e.g., if two machines have 100 and 200 GB memory, respectively, the former could have a weight of ⅓ and the latter of ⅔. Additionally, these per-machine weights can be used in distributed graph system to achieve custom placements (in which case, the placement manager should guarantee that the balancing decisions are stable).

The rebalancer executes mainly between commands and when the system is idle and is responsible for managing/improving the following scenarios:
1. New machine join: Rebalancing ensures that the new machine will eventually host almost the same amount of data (with respect to each machine's weight) as the existing machines by balancing all graphs.
2. Machine removal: Rebalancing ensures that the machine to be removed will eventually become empty and the remaining machines will host the balanced amounts of data.
3. Memory requirement changes: The resource manager (responsible for allocating memory to commands) or the control plane requests that the rebalancing manager makes memory space on a specific machine to achieve some other operation. The rebalancer can adjust the graph weights and move data out of the specific machines, similar with “Machine removal.”

This design allows the rebalancer to be flexible in many aspects implementation-wise (e.g., with policies on how and when to rebalance). Additionally, rebalancing can operate regardless of the chunk transfer implementing, e.g., over a shared filesystem (such as, NFS, HDFS) or cloud object store, or directly over message passing. In case rebalancing is coupled together with graph backups on shared storage (i.e., the graph chunks are replicated in storage for persistence), the rebalancer can leverage this and fetch data directly from shared storage as needed, removing the need for on-demand serialization of chunks.

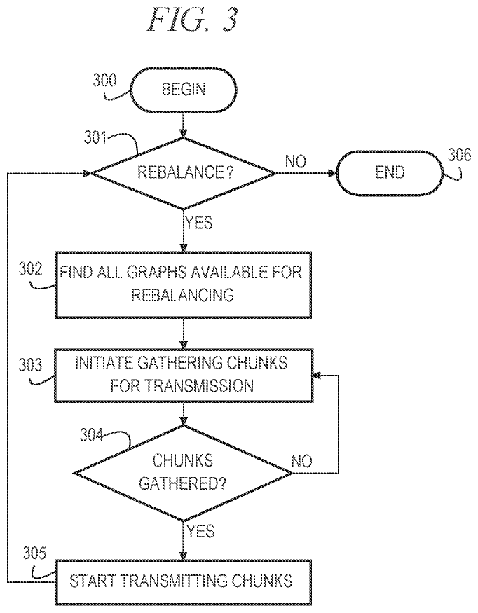

In particular, when a new machine joins due to elasticity, the rebalancer detects that the already loaded graphs are imbalanced and performs the rebalancing approach. FIG. 3 is a flowchart illustrating rebalancing of graph data among machines in a cluster in accordance with an illustrative embodiment. Operation begins (block 300), and the distributed graph processing system determines whether to perform a rebalancing operation (block 301). If there is an imbalance and the distributed graph processing system determines to perform a rebalancing operation (block 301: YES), then the system finds all graphs available for rebalancing (block 302). The system also finds the most imbalanced graph based on the number of chunks with respect to each machine's weight. The system initiates gathering chunks for transmission (block 303). The system determines whether all chunks have been gathered (block 304). Transmission only starts when all chunks or a sufficient number of chunks have been gathered. As described below, the rebalancing can be configured to limit the number of chunks that can be transmitted at a time. Thus, the rebalancing operation may begin transmitting chunks when a sufficient number of chunks, i.e., a limited number of chunks, have been gathered even if all possible chunks for transmission have not been gathered. If a sufficient number of chunks have not been gathered (block 304:NO), operation returns to block 303 to gather chunks.

If all chunks or a sufficient number of chunks have been gathered for transmission (block 304:YES), then the system starts transmitting chunks to a target machine to utilize the available resources (block 305). The overall balancing may be incremental but can be tuned on how aggressive it is. In the case of adding a new machine to the cluster, the system starts transmitting chunks to the new machine being added to the cluster. Transmission of the chunks can be done for multiple graphs in parallel and at the same time.

Thereafter, operation returns to block 301 to determine whether to perform a rebalancing operation. Rebalancing may end if there is no longer an imbalance; however, rebalancing may also end even though there is still an imbalance. For example, one can limit the number of chunks transmitted at a time. If the system determines to perform a rebalancing operation (block 301:YES), then execution of blocks 302-305 repeat. If the system determines not to perform a rebalancing operation (block 301:NO), then operation ends (block 306).

Although chunks are of similar memory size by design to simplify rebalancing, choosing which graph chunks to move from one machine to another can use partitioning heuristics to optimize for performance. In distributed graphs for example, a common partitioning optimization criterion is to reduce the number of remote edges, namely of edges (src)−[edge](dst) that have src and dst vertices on different machines. Chunk statistics can help make optimized decisions for keeping the number of remote edges low even after rebalancing. For instance, for each chunk C1 a map from (other chunk C2)(#vertices in C2 that are destinations of edges of C1) can be kept. When several chunks can be rebalanced from one machine to another, the one that will be chosen is the one that minimizes the number of remote edges on both the source machine and the target machine.

Rebalancing can of course be parallelized, with various graphs and chunks of graphs being simultaneously in flight. This parallelism is configurable, possibly limiting the amount of resources, namely network bandwidth and maximum extra memory, that the rebalancer can use.

Depending on the underlying implementation, rebalancing a graph can be an exclusive operation (i.e., it cannot happen in parallel with other graph operations that access the same graph), or it can be implemented in a way that allows read-only analysis (and certain localized mutation operations) to happen in parallel with rebalancing. Either way, rebalancing happens incrementally and can be stopped/resumed at a chunk granularity. Given the requirement for small/medium size chunks, this means that exclusive rebalancing can delay another command just for short periods. In that sense, rebalancing is cancelable in that if a user command needs to access the graph and it cannot proceed in parallel with rebalancing, rebalancing can be quickly interrupted.

To support machine removals, i.e., cluster shrinking, the system can set the weight of the machine to be removed to 0 (i.e., this machine should not hold any data). The rebalancer is eventually triggered after this update and will gradually start moving data out this machine. Once it is actually empty, the system will remove it from the cluster. (Of course, the rebalancer can be configured to be more aggressive for certain operations, e.g., to expedite evacuating a machine.)

### Graph Data Structures

The graph data structures described herein provide examples for a system on which the illustrative embodiments may be implemented. Implementations of the illustrative embodiments are not limited to these example graph data structures or systems.

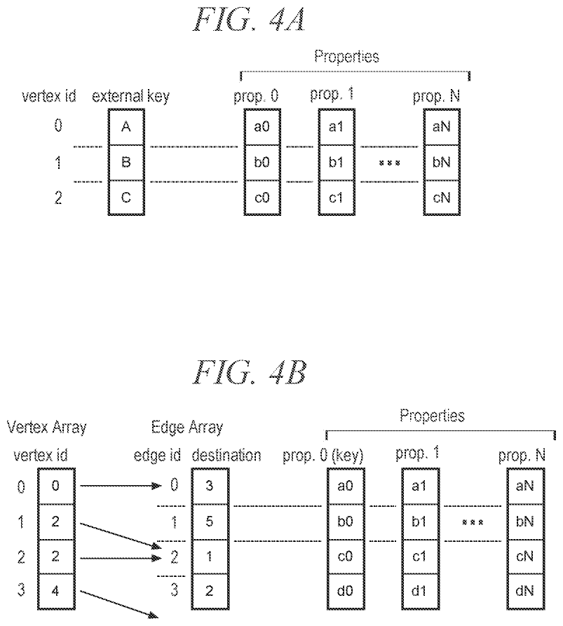

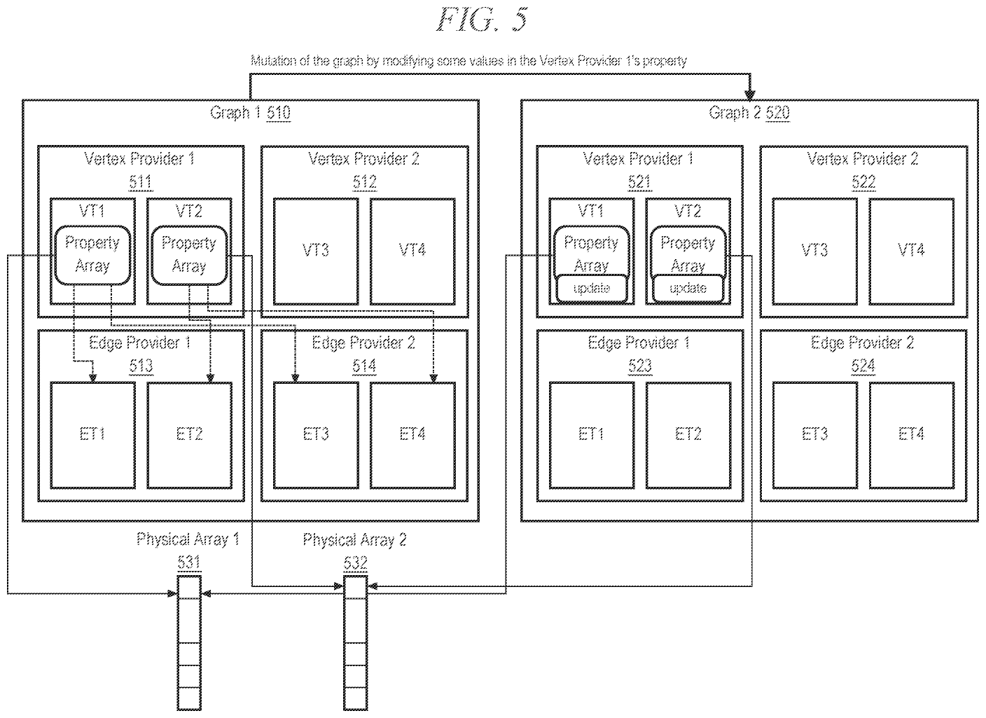

In some embodiments, vertices are stored in vertex tables. A vertex table stores the unique external key of the vertices (which is used by the user to refer to each vertex) and the properties in arrays. There is one array per property, each with one entry per vertex. FIG. 4A shows an example of a vertex table in accordance with an illustrative embodiment. Here, vertex ID is used internally to reference a vertex, while the external vertex key is used by the user to reference a vertex. Both are unique. Each machine holds a distinct set of vertex tables.

Vertices (and edges) can have different types. For each vertex type, vertices have a different set of properties. Each type, called “provider” in this disclosure, has a specific set of vertex tables. Vertices are distributed such that each table in a given provider holds approximately the same number of vertices for each degree. All vertices are owned and stored by a single table (and machine, called data owner).

In some embodiments, edges are stored in a Compressed Sparse Row (CSR) format, on the data owner machine of their sources. Edge properties are stored alongside the edges in columns. FIG. 4B shows an example of edge data structures with properties in accordance with an illustrative embodiment. For a given edge table, all the edges have their source in a single vertex table and their destination in a (potentially different) single vertex table. Note that vertex 3 in FIG. 4B does not exist, but the entry is present in the CSR as sentinel.

For several applications, it is useful to be able to navigate the edges in their reverse direction (e.g., finding all vertices with an edge to a given vertex). Therefore, the system may also store a reverse CSR, with all the edges duplicated in the reverse direction (reverse edges can bring significant performance benefits but can of course been disabled to save memory). Note that, due to the distributed aspect, the forward edge and its reverse version are on the same machine if and only if the source and destination vertices are on the same machines.

Similar to vertex tables, each machine holds a distinct set of forward edge tables and another set of reverse edge tables. If a machine owns a specific vertex table, then it also owns all forward edge tables whose edges have their source in the vertex table. Similarly, it also owns all reverse edge tables whose edges have their destination in the specific vertex table. Those forward and reverse edge tables are referred to as linked edge tables to the vertex table.

This ensures that the neighborhood of local vertices for a given machine can always be read locally (note that since the system is distributed, this does not mean that the destination vertex of a given edge is local as well). Unlike other distributed systems that store the data in a relational manner, distributed graph systems must ensure, for best performance, that all forward edges of a given vertex are stored on the same machine as the vertex itself. If that is not the case, iteration over the neighbors of a given vertex would be slow as access to the edges of a vertex could result in network communication, which is orders of magnitude slower than direct memory access. In this disclosure, we ensure that the neighborhood of each vertex is always kept on the same machine as the vertex, even when the vertex is moved to the new machine.

The graph also stores a dictionary that maps the external vertex keys to the tuple {vertex table ID, vertex id in the table}. The machine that stores the dictionary entry for a vertex is given by a hash function applied to the key. This machine is the hash owner of the vertex. This machine is not necessarily the same one that owns the vertex data.

In order to process updates to graphs efficiently, the system also assumes that the system is using a delta mechanism for creating logical graphs from the same underlying physical graph data structures. With such a mechanism, when a user wants to modify a graph, the system will create a new graph that is a shallow copy of the original graph. The new graph will have the same set of vertex and edge tables as the original one, with the same property arrays. The only difference is that the new graph will also store the differences compared to the old graph (e.g., deletion of vertices, modification of property values, etc.). The set of graphs that originate from a single graph is referred to as a history in this disclosure.

When shallow copies of vertex/edge tables are created, each of the properties are shared between the shallow copies. In practice, in a vertex/edge table each property consists of a property array (which is basically a structure containing a pointer and the updates for this version of the graph) that points to a physical array (which is a contiguous array that holds the shared data from the base graph).

In order to improve the clarity of the explanations below, the following definitions are introduced. “Equivalent tables” are shallow copies of the same original vertex or edge table in a history of graphs. A “chunk” is a vertex table with its linked edge tables in a simple case (for a graph with an empty history) or contains all of the equivalent vertex tables and all the edge tables that are linked with those vertex tables from all graphs in the history in the more complex case in a history. “Equivalent Chunks (EC)” is a set of chunks that have their vertex tables originating from the same history of graphs, in the same vertex provider. Each chunk in an EC is approximately the same size and has the same number of (vertex and edge) tables.

FIG. 5 is a block diagram illustrating the data structures for a history of graphs in accordance with an illustrative embodiment. To simplify the diagram, some simplifications have been made:
Assume single machine in the cluster (hence all tables are present);
Assume one property for Vertex Provider 1, and none for the others;
Reverse edge tables are not shown;
Assume that only Vertex Provider 1 has forward edges (not Vertex Provider 2);
Assume that the history only contains two graphs.

FIG. 5 shows several vertex (VT1, VT2, . . . ) and edge tables (ET1, ET2, . . . ) contained in different providers. Graph 1 510 has Vertex Provider 1 511 with vertex tables VT1 and VT2, Vertex Provider 2 512 with vertex tables VT3 and VT4, Edge Provider 513 with edge tables ET1 and ET2, and Edge Provider 2 514 with edge tables ET3 and ET4. Graph 2 520 has Vertex Provider 1 521 with vertex tables VT1 and VT2, Vertex Provider 2 522 with vertex tables VT3 and VT4, Edge Provider 523 with edge tables ET1 and ET2, and Edge Provider 2 524 with edge tables ET3 and ET4. In the example shown in FIG. 5, Graph 2 520 is formed by a mutation of Graph 1 510 by modifying some values in the Vertex Provider 1 511 property, shown as “update” in Vertex Provider 1 521 in Graph 2 520.

Linked tables are shown with dotted lines (not shown in Graph 2 520 for clarity). For instance, in both Graph 1 510 and Graph 2 520, VT1 is linked with ET1 and ET3. VT1 in Graph 1 510 and VT1 in Graph 2 520 are equivalent tables (same for all vertex/edge tables that have the same name). In the example shown in FIG. 5, tables VT1, ET1, and ET3 from both graphs form one chunk; tables VT2, ET2, and ET4 form another chunk; table VT3 forms one chunk; and table VT4 forms another chunk. The chunk formed with tables VT1, ET1, and ET3 is equivalent to the chunk formed with tables VT2, ET2, and ET4. Similarly, the chunk formed with table VT3 is equivalent to the chunk formed with table VT4, but the chunk formed with tables VT1, ET1, and ET3 is not equivalent the chunk formed with table VT3. Both VT1s and VT2s have a single property array. The property arrays from both VT1s are pointing to the same physical array 531, and the property arrays from both VT2s are pointing to the same physical array 532.

### User-System Interactions

In any graph system, users can submit commands to the system, such as loading a new graph or running a graph query or algorithm. When executing a user command, the system will allocate memory to the command when requested (e.g., when loading a graph). In any dynamically elastic graph system, if the system lacks memory, the command is put on-hold and the system monitors the available resources and unblocks the command as soon as it has enough resources to continue. This operation is often transparent to the user. In most systems, if after a long time (configurable), there are still not enough resources to run the command, it is cancelled, and the user gets notified. In the meantime, the system also tries to add new machines to its cluster to increase the available resources via elastic scale out.

### Rebalancing Triggers

Rebalancing runs under the following scenarios:
When the system is idle, every graph is available for rebalancing, and the system may rebalance aggressively but may stop rebalancing as soon as a command arrives.
Before a command executes, graphs owned by the user that runs the commands and all other graphs from other idle users are available for rebalancing. In this case, the system may prioritize: (1) graphs used by the command, (2) graphs owned by the user, and (3) all others. The system will send a few chunks to speed up the command.
Commands may be on hold due to elasticity scale in/out. If a user has a command that is on-hold, then there is no command currently running in the system for this user, and the user's graphs are available for rebalancing. The system will prioritize graphs required by the on-hold command. The system will rebalance aggressively to enable the execution of the on-hold command.
During a command execution, the graph used by the command is available for rebalancing and is prioritized by the system. The command can give some hints regarding how many chunks should be sent; otherwise, the rebalancer will send only a few chunks.

Regarding the last point, the rebalancer allows commands to call it when the commands detect that there are imbalances between the machines and that rebalancing could help. In such a case, the command itself may trigger the rebalancing when it reaches a “safe-point” (i.e., a point during the execution of the command where there is no graph data access on any machines); otherwise, rebalancing could move data that is being accessed/modified. The command will also hint to the rebalancer roughly how many chunks should be sent.

Consider an example of incremental rebalancing during execution of PageRank, which is a very well known graph algorithm that performs several processing iterations over the vertices of a graph to determine the “importance” of each vertex. A simplified implementation of PageRank is as follows:

```
do {
  compute_vertex_ranking_in_iteration( ); // implementation not
shown for simplicity
  cnt++
} while (cnt < max_inter);
```

In order to leverage rebalancing, some small code can be added to the implementation. As mentioned above, the rebalancer can only run at “safe-points” (when no graph data is accessed). In this example, a safe-point would be after compute_vertex_ranking_in_iteration has been called.

Before calling the rebalancer, the command can give some hints regarding its assessed imbalanced of the graph. A simple metric here would be that each machine measures how long it took to run the function in the iteration. The higher the difference in runtime, the higher the chance that the graph is imbalanced.

The new code with a rebalancing call during command execution would look like this:

```
do {
  double exec_time = compute_vertex_ranking_in_iteration( ); // implementation
not shown for simplicity
  int max_num_chunks_to_rebalance = compute_max_num_chunks(exec_time); //
heuristic that returns a good number of chunks to rebalance given the
difference in exec times from all machines
  if (max_num_chunks_to_rebalance > 0) {
  try_rebalance_graph(max_num_chunks_to_rebalance);
  }
  cnt++
} while (cnt < max_inter);
```

Consider an example of incremental rebalancing during query execution. Rebalancing can also be run during a query. However, the query needs to be executed in a certain way, so that it contains safe-points. A query execution model that would allow such safe-points is Breadth First Traversal (BFT). With this model, the query is executed in sequential stages, where each stage corresponds to one hop, from the vertices matched at the previous stage, to their neighbors (taking the possible filters into account). In this model, rebalancing can be run in-between stages, as no graph data is accessed.

### Graph Rebalancing—Preparation

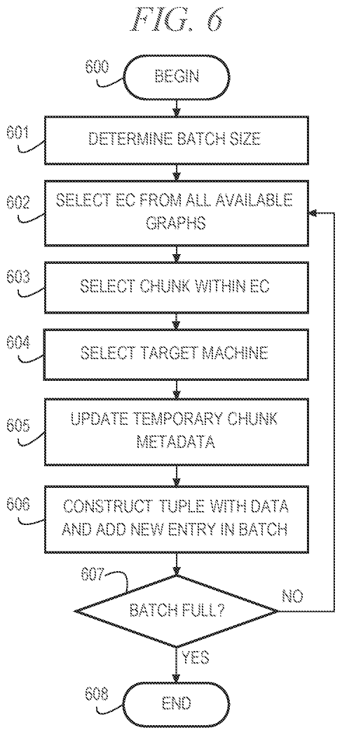

FIG. 6 is a flowchart illustrating high level operation of rebalancing before starting transmission of data in accordance with an illustrative embodiment. Operation begins (block 600), and the system determines a batch size (block 601). The first operation that the system does when triggered is to determine how many chunks it can send in a run. The chunks that will be transmitted during one run of the rebalancer are called a batch. When the system is idle, it keeps rebalancing chunks. If a new command arrives, the rebalancing is cancelled (already transmitted chunks will not be reverted). Between commands, only a few chunks are sent to avoid stalling commands for a long time. If an on-hold command is to be resumed, the rebalancer will try to rebalance as many chunks as it can, in case a new machine joins to enable the execution of the blocked command.

The system selects a set of equivalent chunks, EC, from all available graphs (block 602). The EC ranking is a metric that shows which EC should be prioritized for rebalancing. EC ranking takes several parameters into account, such as graphs that are prioritized and graphs used by on-hold commands. Note that some ECs might not be available because their graphs might be used by a command. In this case, they will not be considered. The calculation of the EC ranking works as follows:

Calculate the target number of chunks each machine has to hold. This could be different for each machine as it depends on the per machine weights.

Compute the difference between the current chunks each machine holds and the target number.

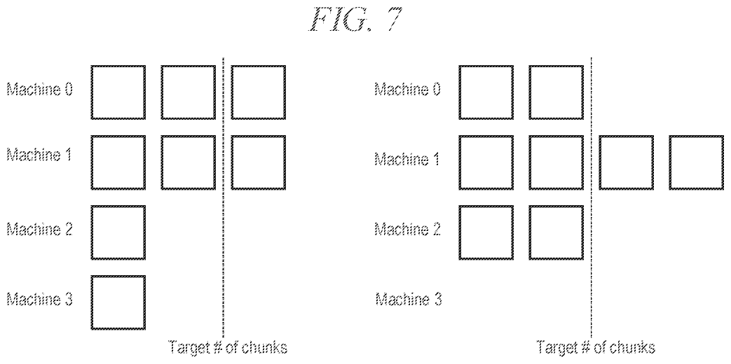

The base rank is a function of the differences, such as sum of the absolute values, or sum of the squares. FIG. 7 depicts example distributions of chunks across four machines for which Equivalent Chunks ranking may be calculated in accordance with an illustrative embodiment. Each square is a chunk. The base ranking will depend on the function chosen by the administrator. For instance in both distributions shown in FIG. 7, the sum of the absolute values of the differences is used, and the ranking is 4. For the distribution on the left, the ranking is as follows:

$$ranking = abs ( 1 ) + abs ( 1 ) + abs ( - 1 ) + abs ( - 1 ) = 4$$

The ranking on the right is as follows:

$$ranking = abs ( 0 ) + abs ( 2 ) + abs ( 0 ) + abs ( - 2 ) = 4$$

However, with a different ranking function, for instance sum of squares, the ranking for the distribution on the left is as follows:

$$ranking = {1}^{2} + {1}^{2} + {( - 1 )}^{2} + {( - 1 )}^{2} = 4$$

The ranking on the right is as follows:

$$ranking = {0}^{2} + {2}^{2} + {0}^{2} + {( - 2 )}^{2} = 8$$

In one embodiment, to correctly rank EC, the context of the rebalancing is taken into consideration. For example, if transferring an EC will unblock an on-hold command, its ranking is highly increased to rebalance it with a very high priority. Similarly, if the EC is used by the next command, then its ranking is also increased (but by a smaller margin). Extra weights could be used to affect the EC ranking such as the size of each chunk in the EC.

After all available ECs have been given a ranking, the rebalancer picks the one with the highest score and proceeds to the next step.

The system then elects a chunk within the EC (block 603). The system first determines which machine has the largest excess chunks compared to its target number of chunks for the chosen EC. Then, one chunk among all the chunks of this EC on this machine is selected. Chunks are roughly equivalent, but for better performance, an informed decision may be made using, for instance, the actual memory size of the chunks or by picking the chunk that would create the most local edges. As described above, when several chunks can be rebalanced from one machine to another, the one that will be chosen is the one that minimizes the number of remote edges on both the source machine and the target machine.

The system then selects a target machine (block 604). With the simplest policy, the new machine that should own the chunk is the one that is lacking the most chunks according to its weight. However, as mentioned with respect to block 604 above, more advanced policies can be devised that consider the graph partitioning. In such a case, blocks 603 and 604 can be optimized together.

FIG. 8 illustrates an example of a simple policy for selecting a target machine in accordance with an illustrative embodiment. There are ten chunks in total. Each number in the circle is the number of chunks for each machine. The floating-point number above each circle is the weight for the machine. The target number of chunks for each machine is as follows: M1, 0.3*10=3; M2, 2; M3, 1; M4, 2; and M5, 2.

In the first step, M1 is the machine with the most excess chunks (and will remain until the end of the rebalancing). Therefore, M1 is the source of the transfers in this example. M4 is lacking one chunk and M5 is lacking two chunks. Thus, M1 sends one chunk to M5. In the second step, both M4 and M5 are lacking one chunk. M1 sends one chunk to M4 (chosen because M5 received a chunk the previous step). In the third step, only M5 is lacking one chunk. M1 sends one chunk to M5. In the fourth step, the graph is balanced.

Note that machines that are already balanced (or overprovisioned) for this EC will not be considered as targets, to avoid creating an imbalance. Only machines that are lacking chunks will be considered. Furthermore, because chunks are coarse-grained, it is difficult in practice to exactly match each machine's weight with its number of chunks. For instance, if the weight for M1 is 0.4, and the weight for M2 is 0.6, then if the EC has only two chunks, perfect balance cannot be reached. Still the best distribution in this case is one chunk for each machine. The rebalancer will make sure that only chunk transfers that will improve overall balance of the EC will be considered. In the previous example, if both machines have one chunk, then every move (i.e., moving one chunk from M1 to M2 or 1 chunk from M2 to M1) will decrease the balance, and therefore will not be considered.

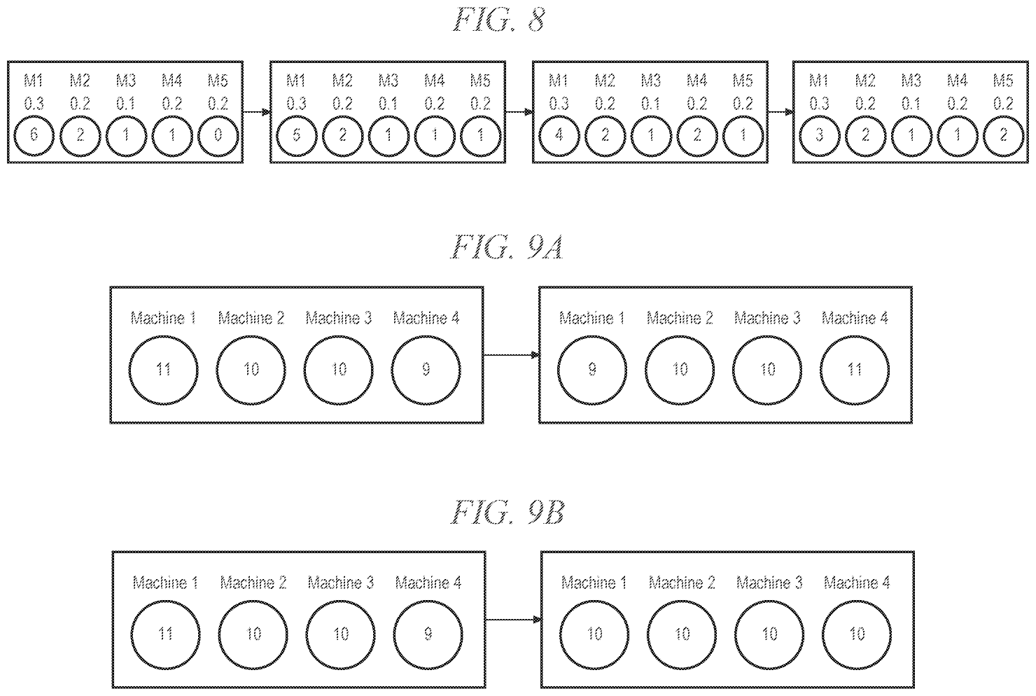

The system updates temporary chunk metadata (block 605). When a chunk is selected in the batch, the choice for the next chunk is taken as if the previous chunks were rebalanced based on the temporary chunk metadata. When selecting a chunk in the batch, the choice for the next chunk must be taken as if the previous chunk(s) were already rebalanced (although in practice they will be rebalanced in parallel). FIG. 9A illustrates an example of selecting a target machine with no provider metadata update in accordance with an illustrative embodiment. The numbers inside the circles represent the chunks that each machine has. The batch size is two (2). In the example depicted in FIG. 9A, if the system does not update the provider metadata after selecting a chunk, the system selects two chunks from the first machine (Machine 1) and has a new imbalanced machine (Machine 4) after rebalancing. FIG. 9B illustrates an example of selecting a target machine with provider metadata update after putting a chunk in the batch in accordance with an illustrative embodiment. In the example depicted in FIG. 9B, the second chunk is not added to the batch after the first chunk, because the system determines that adding the second chunk would create an imbalance based on the updated temporary chunk metadata.

Thereafter, the system constructs a tuple with the data from blocks 602-604 and adds a new entry in the batch (block 606). The system determines whether the batch is full (block 607). If the batch is not full (block 607:NO), then operation returns to block 602 to repeat until the batch is full (block 607:YES), at which point, operation ends (block 608).

### Graph Rebalancing—Chunks Transmission

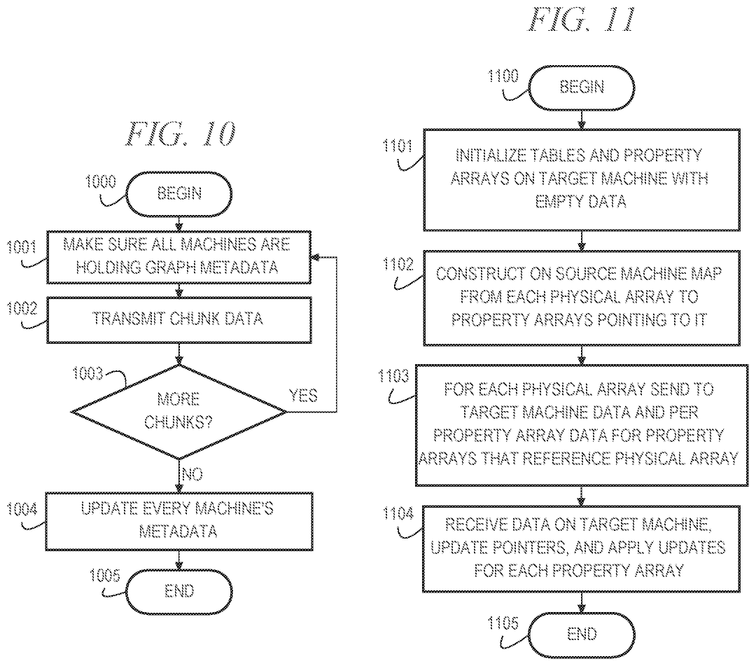

FIG. 10 is a flowchart illustrating chunk transmission in accordance with an illustrative embodiment. Operation begins (block 1000), and the system makes sure that all machines are holding the graph's metadata (block 1001). Before chunks can be transmitted, the system makes sure that the target machine is aware of the graph's metadata. When new machines join the cluster, all graph metadata is usually exchanged lazily, i.e., only when a command that uses the graph arrives. In block 1001, the system sends the required graph metadata to the new machine (information about number of vertex/edge tables, properties, etc.).

The system then transmits chunk data (block 1002). Because the set of chunks to be transferred has been established in the preparation phase, the system has all the info it needs to exchange the batch of chunks in the most efficient manner. As mentioned above, the system can be configured to follow some constraints, in order to minimize the performance impact of rebalancing (but at the expense of making the chunk transfer longer). Such configurations include setting the maximum number of chunks in flight, or maximum memory overhead, or maximum network bandwidth usage.

In one embodiment, each machine that has chunks to send will send at most one chunk at a time. Sending more will not increase performance, as the sending of a single chunk fully utilizes the outgoing network bandwidth of the machine. However, if every machine that has to send chunks does it at the same time, this might result in performance degradation as the network will likely be flooded. This can happen frequently when a new machine joins, and every other machine is sending data to the new machine. Therefore, the system may also prevent some machines from sending their chunk's data until some others are finished. This scheduling is performed at runtime (i.e., while the chunks are being exchanged) to ensure the best performance, as a scheduling that would be performed before sending will likely be sub-optimal because of runtime variations of the system (e.g., other processes running and slowing some machines down, or slight variation in the execution of the exchange because of the operating system's calls).

During the exchange of the chunks in the batch, the system monitors the global state of the system (number of chunks in-flight, memory consumption on all machines, network usage, etc.). If a constraint from the configuration is violated (e.g., too much data is sent over the network), the system will throttle the sending machines. On the contrary, if there is available network bandwidth on a receiving machine, the system will instruct a corresponding sender to start sending its chunk.

FIG. 11 is a flowchart illustrating sending and receiving a chunk in accordance with an illustrative embodiment. In some embodiments, the data within a chunk only consists of property arrays (which are basically just pointers to shared physical arrays), which are referenced via the vertex and edge tables of the chunk. Sending a chunk's data is therefore equivalent to sending its property arrays. In the depicted example, sending the chunk data is performed with direct message-passing transmission of data. The solution over shared storage simply serializes the same data to files. Operation begins (block 1100), and the system initializes tables and property arrays on the target machine with empty data (block 1101). At this stage, the system is not concerned with sharing. The system then constructs on the source machine a map from each physical array to the property arrays pointing to it (block 1102). Then, for each physical array, the system sends to the target machine the physical array data and the per-property array data for property arrays that reference the physical array (block 1103). The system receives the data on the target machine, updates the pointers, and applies updates for each property array (block 1104). Thereafter, operation ends (block 1105).

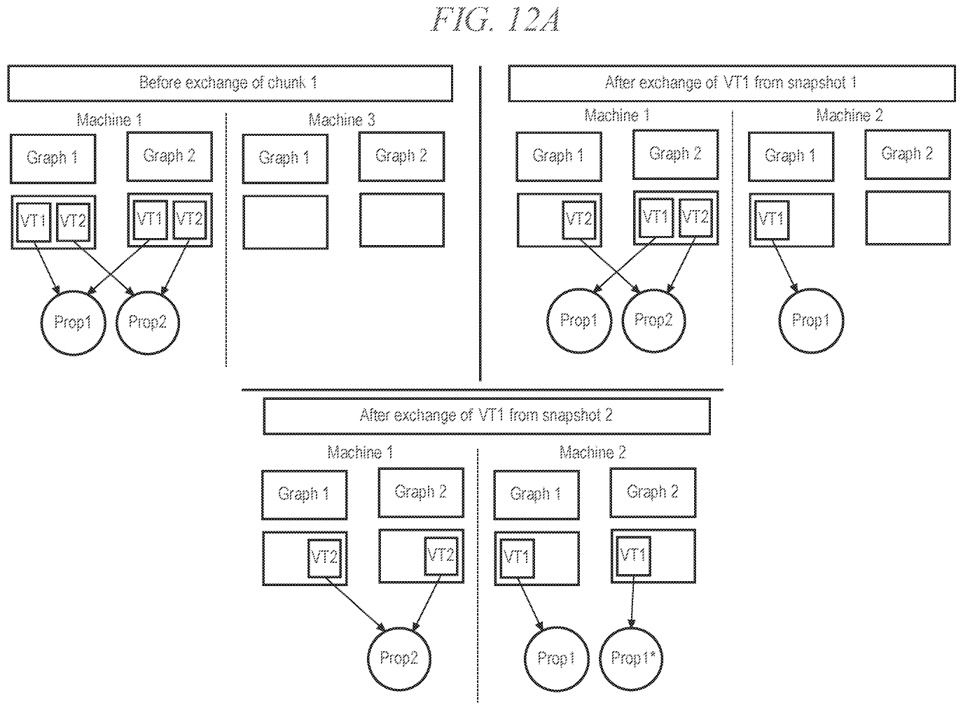

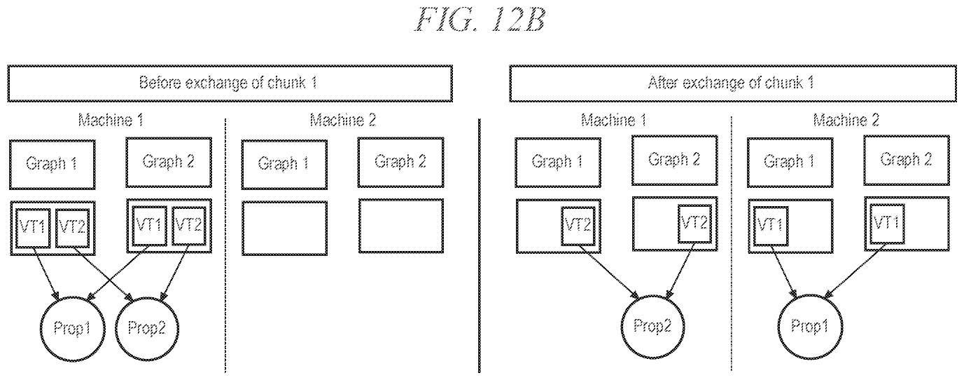

In some embodiments, to avoid data duplication, the system moves vertex/edge tables that share the same physical arrays in a single chunk transfer. If these vertex/edge tables are not rebalanced as a single chunk, this may result in a state where the data for the same physical array are duplicated, thus using more memory than needed. Thus, the system considers all graphs in a history before sending a chunk and does not simply process each graph individually. FIG. 12A depicts chunk transfer resulting in data duplication in accordance with an illustrative embodiment. In this example, two graphs are in the same history. Each graph has two vertex tables, initially on the same machine. The graphs share two physical arrays (Prop1 and Prop2). Before exchange of chunk1, vertex tables VT1 and VT2 for Graph 1 and Graph 2 are on Machine 1. Vertex tables VT1 in Graph 1 and Graph 2 link to property array Prop1, and vertex tables VT2 in Graph 1 and Graph 2 link to property array Prop2.

After exchange of vertex table VT1 from Graph 1 in snapshot 1, the physical array for property 1 Prop1 is sent to Machine 2, and VT1 in Graph 1 links to Prop1 in Machine 2. Note that vertex table VT1 in Graph 2 of Machine 1 still links to property 1 Prop1 in Machine 1; therefore, the property array Prop1 exists on both Machine 1 and Machine 2.

After exchange of vertex table VT1 from Graph 2 in snapshot 2, the physical array for property 1 Prop1 is sent to Machine 2, and VT2 in Graph 2 links to Prop1 in Machine 2. Because VT1 was transferred in two separate steps from two different snapshots, this results in two copies of the physical array for property 1 Prop1 and Prop1*.

FIG. 12B depicts chunk transfer with physical array de-duplication in accordance with an illustrative embodiment. In this example, two graphs are in the same history. Each graph has two vertex tables, initially on the same machine. The graphs share two physical arrays (Prop1 and Prop2). Before exchange of chunk1, vertex tables VT1 and VT2 for Graph 1 and Graph 2 are on Machine 1. Vertex tables VT1 in Graph 1 and Graph 2 link to property array Prop1, and vertex tables VT2 in Graph 1 and Graph 2 link to property array Prop2.

The system moves vertex/edge tables that share the same physical arrays in a single chunk transfer. That is, the copies of vertex table VT1 from both Graph 1 and Graph 2 are exchanged, along with property array Prop1, in a single chunk transfer. Thus, only one copy of Prop1 exists on Machine 2 after the chunk transfer.

In case the system is configured to make periodic backups of its data to a shared persistent storage, the system does not transmit the chunk data via message passing, but rather leverages the fact that the data is already accessible to all machines. In such a case, if a machine is instructed to prepare to receive a chunk from another machine, instead of waiting for the network data, the destination machine simply reads the data directly from the persistent storage without any input from the source machine. The source machine then deallocates its physical arrays without having to send them.

Returning to FIG. 10, the system determines whether there are more chunks to transfer (block 1003). If there are more chunks to transfer (block 1003:YES), then operation returns to block 1001. If there are no more chunks to transfer (block 1003:NO), then the system updates every machine's metadata (block 1004). After having sent every chunk, the metadata of the graphs is updated. For instance, the vertex count per machine, ownership mapping, etc. is properly set. Thereafter, operation ends (block 1005).

### Cluster Shrinking

The system handles shrinking using the same mechanism as when a machine is joining. When a machine is chosen to be removed from the cluster, the weight of this machine will be set to 0 (zero). The system then initiates the rebalancing procedure to redistribute all the chunks out of this machine uniformly once it runs. Thus, returning to FIG. 3, with a machine weight set to zero, an imbalance will be detected in block 301, and the most imbalanced graph will be a graph on the machine to be removed because the target number of chunks for that machine will be zero.

### Rebalancing Stability

A very important feature of the rebalancing approach in the illustrative embodiments is that, given a balance metric, it should eventually reach a stable state where the system has the least imbalance. Once it reaches this state, it should not perform any more rebalancing actions (e.g., it should avoid “ping-ponging” chunks between machines). The system of the illustrative embodiments fulfills these requirements. Since it can run between commands, when the system is idle, or even when within a command at predefined “safe-points,” the rebalancing procedure will run frequently. Each time it runs, it will, for the available graphs, pick chunks that, if moved, would decrease the imbalance of the system. The rebalancing procedure only becomes idle when there is no chunk transfer that would decrease the imbalance. When such a state has been reached, and because there are no local minima in the imbalance (i.e., if no move can decrease the imbalance, then, the global minimum in imbalance has been reached), the rebalancing procedure has attained its goal and will remain idle until the distribution of the machines' weights changes.

Rebalancing with a Scheduler

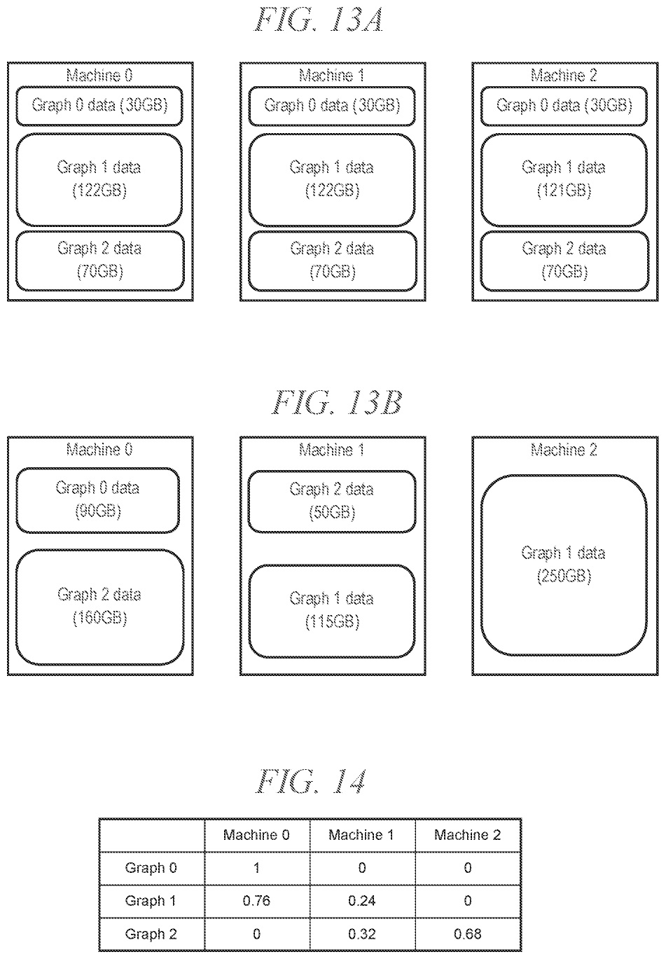

The rebalancing policies of the illustrative embodiments are stable. Still, the rebalancing procedure of the illustrative embodiments enables graph systems to potentially use explicit graph placement scheduling to optimize specific use cases. FIG. 13A illustrates placement of graph data on a cluster of machines according to a default policy to bring graphs into a balance in accordance with an illustrative embodiment. With a uniform memory-usage distribution, each graph takes up approximately the same amount of memory on each machine.

However, some use cases might benefit from a graph being consolidated and placed different on the machines of a cluster. FIG. 13B illustrates placement of graph data on a cluster of machines according to explicit graph placement scheduling in accordance with an illustrative embodiment. As shown in the example of FIG. 13B, the smallest graph, Graph 0, lies in a single machine, and the largest graph, Graph 1, has Machine 2 exclusively and shares Machine 1 with Graph 2. The rebalancing procedure in the illustrative embodiment can easily support such configurations, where a placement/scheduling layer instructs the rebalancing procedure on the weights to use for each graph. FIG. 14 is an example table illustrating per-machine weights for each graph in accordance with an illustrative embodiment. As seen in the depicted example, Graph 0 has a weight of 1 for Machine 0 and a weight of 0 for Machine 1 and Machine 2, indicating that Graph 0 is to be placed on only Machine 0. Graph 1 is to be distributed between Machine 0 and Machine 1, and Graph 2 is to be distributed between Machine 1 and Machine 2 according to the specified weights. Note that in such usage of the rebalancing procedure, the placement manager should guarantee that the balancing decisions are stable.

### DBMS Overview

A database management system (DBMS) manages a database. A DBMS may comprise one or more database servers. A database comprises database data and a database dictionary that are stored on a persistent memory mechanism, such as a set of hard disks. Database data may be stored in one or more collections of records. The data within each record is organized into one or more attributes. In relational DBMSs, the collections are referred to as tables (or data frames), the records are referred to as records, and the attributes are referred to as attributes. In a document DBMS (“DOCS”), a collection of records is a collection of documents, each of which may be a data object marked up in a hierarchical-markup language, such as a JSON object or XML document. The attributes are referred to as JSON fields or XML elements. A relational DBMS may also store hierarchically marked data objects; however, the hierarchically marked data objects are contained in an attribute of record, such as JSON typed attribute.

Users interact with a database server of a DBMS by submitting to the database server commands that cause the database server to perform operations on data stored in a database. A user may be one or more applications running on a client computer that interacts with a database server. Multiple users may also be referred to herein collectively as a user.

A database command may be in the form of a database statement that conforms to a database language. A database language for expressing the database commands is the Structured Query Language (SQL). There are many different versions of SQL; some versions are standard and some proprietary, and there are a variety of extensions. Data definition language (“DDL”) commands are issued to a database server to create or configure data objects referred to herein as database objects, such as tables, views, or complex data types. SQL/XML is a common extension of SQL used when manipulating XML data in an object-relational database. Another database language for expressing database commands is Spark™ SQL, which uses a syntax based on function or method invocations.

In a DOCS, a database command may be in the form of functions or object method calls that invoke CRUD (Create Read Update Delete) operations. An example of an API for such functions and method calls is MQL (MondoDB™ Query Language). In a DOCS, database objects include a collection of documents, a document, a view, or fields defined by a JSON schema for a collection. A view may be created by invoking a function provided by the DBMS for creating views in a database.

Changes to a database in a DBMS are made using transaction processing. A database transaction is a set of operations that change database data. In a DBMS, a database transaction is initiated in response to a database command requesting a change, such as a DML command requesting an update, insert of a record, or a delete of a record or a CRUD object method invocation requesting to create, update or delete a document. DML commands and DDL specify changes to data, such as INSERT and UPDATE statements. A DML statement or command does not refer to a statement or command that merely queries database data. Committing a transaction refers to making the changes for a transaction permanent.

Under transaction processing, all the changes for a transaction are made atomically. When a transaction is committed, either all changes are committed, or the transaction is rolled back. These changes are recorded in change records, which may include redo records and undo records. Redo records may be used to reapply changes made to a data block. Undo records are used to reverse or undo changes made to a data block by a transaction.

An example of such transactional metadata includes change records that record changes made by transactions to database data. Another example of transactional metadata is embedded transactional metadata stored within the database data, the embedded transactional metadata describing transactions that changed the database data.

Undo records are used to provide transactional consistency by performing operations referred to herein as consistency operations. Each undo record is associated with a logical time. An example of logical time is a system change number (SCN). An SCN may be maintained using a Lamporting mechanism, for example. For data blocks that are read to compute a database command, a DBMS applies the needed undo records to copies of the data blocks to bring the copies to a state consistent with the snap-shot time of the query. The DBMS determines which undo records to apply to a data block based on the respective logical times associated with the undo records.

In a distributed transaction, multiple DBMSs commit a distributed transaction using a two-phase commit approach. Each DBMS executes a local transaction in a branch transaction of the distributed transaction. One DBMS, the coordinating DBMS, is responsible for coordinating the commitment of the transaction on one or more other database systems. The other DBMSs are referred to herein as participating DBMSs.

A two-phase commit involves two phases, the prepare-to-commit phase, and the commit phase. In the prepare-to-commit phase, branch transaction is prepared in each of the participating database systems. When a branch transaction is prepared on a DBMS, the database is in a “prepared state” such that it can guarantee that modifications executed as part of a branch transaction to the database data can be committed. This guarantee may entail storing change records for the branch transaction persistently. A participating DBMS acknowledges when it has completed the prepare-to-commit phase and has entered a prepared state for the respective branch transaction of the participating DBMS.

In the commit phase, the coordinating database system commits the transaction on the coordinating database system and on the participating database systems. Specifically, the coordinating database system sends messages to the participants requesting that the participants commit the modifications specified by the transaction to data on the participating database systems. The participating database systems and the coordinating database system then commit the transaction.

On the other hand, if a participating database system is unable to prepare or the coordinating database system is unable to commit, then at least one of the database systems is unable to make the changes specified by the transaction. In this case, all of the modifications at each of the participants and the coordinating database system are retracted, restoring each database system to its state prior to the changes.

A client may issue a series of requests, such as requests for execution of queries, to a DBMS by establishing a database session. A database session comprises a particular connection established for a client to a database server through which the client may issue a series of requests. A database session process executes within a database session and processes requests issued by the client through the database session. The database session may generate an execution plan for a query issued by the database session client and marshal slave processes for execution of the execution plan.

The database server may maintain session state data about a database session. The session state data reflects the current state of the session and may contain the identity of the user for which the session is established, services used by the user, instances of object types, language and character set data, statistics about resource usage for the session, temporary variable values generated by processes executing software within the session, storage for cursors, variables, and other information.

A database server includes multiple database processes. Database processes run under the control of the database server (i.e., can be created or terminated by the database server) and perform various database server functions. Database processes include processes running within a database session established for a client.

A database process is a unit of execution. A database process can be a computer system process or thread or a user-defined execution context such as a user thread or fiber. Database processes may also include “database server system” processes that provide services and/or perform functions on behalf of the entire database server. Such database server system processes include listeners, garbage collectors, log writers, and recovery processes.

A multi-node database management system is made up of interconnected computing nodes (“nodes”), each running a database server that shares access to the same database. Typically, the nodes are interconnected via a network and share access, in varying degrees, to shared storage, e.g., shared access to a set of disk drives and data blocks stored thereon. The nodes in a multi-node database system may be in the form of a group of computers (e.g., workstations, personal computers) that are interconnected via a network. Alternately, the nodes may be the nodes of a grid, which is composed of nodes in the form of server blades interconnected with other server blades on a rack.

Each node in a multi-node database system hosts a database server. A server, such as a database server, is a combination of integrated software components and an allocation of computational resources, such as memory, a node, and processes on the node for executing the integrated software components on a processor, the combination of the software and computational resources being dedicated to performing a particular function on behalf of one or more clients.

Resources from multiple nodes in a multi-node database system can be allocated to running a particular database server's software. Each combination of the software and allocation of resources from a node is a server that is referred to herein as a “server instance” or “instance.” A database server may comprise multiple database instances, some or all of which are running on separate computers, including separate server blades.

A database dictionary may comprise multiple data structures that store database metadata. A database dictionary may, for example, comprise multiple files and tables. Portions of the data structures may be cached in main memory of a database server.

When a database object is said to be defined by a database dictionary, the database dictionary contains metadata that defines properties of the database object. For example, metadata in a database dictionary defining a database table may specify the attribute names and data types of the attributes, and one or more files or portions thereof that store data for the table. Metadata in the database dictionary defining a procedure may specify a name of the procedure, the procedure's arguments and the return data type, and the data types of the arguments, and may include source code and a compiled version thereof.

A database object may be defined by the database dictionary, but the metadata in the database dictionary itself may only partly specify the properties of the database object. Other properties may be defined by data structures that may not be considered part of the database dictionary. For example, a user-defined function implemented in a JAVA class may be defined in part by the database dictionary by specifying the name of the user-defined function and by specifying a reference to a file containing the source code of the Java class (i.e., .java file) and the compiled version of the class (i.e., class file).

Native data types are data types supported by a DBMS “out-of-the-box.” Non-native data types, on the other hand, may not be supported by a DBMS out-of-the-box. Non-native data types include user-defined abstract types or object classes. Non-native data types are only recognized and processed in database commands by a DBMS once the non-native data types are defined in the database dictionary of the DBMS, by, for example, issuing DDL statements to the DBMS that define the non-native data types. Native data types do not have to be defined by a database dictionary to be recognized as valid data types and to be processed by a DBMS in database statements. In general, database software of a DBMS is programmed to recognize and process native data types without configuring the DBMS to do so by, for example, defining a data type by issuing DDL statements to the DBMS.

### Hardware Overview

According to one embodiment, the techniques described herein are implemented by one or more special-purpose computing devices. The special-purpose computing devices may be hard-wired to perform the techniques or may include digital electronic devices such as one or more application-specific integrated circuits (ASICs) or field programmable gate arrays (FPGAs) that are persistently programmed to perform the techniques or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

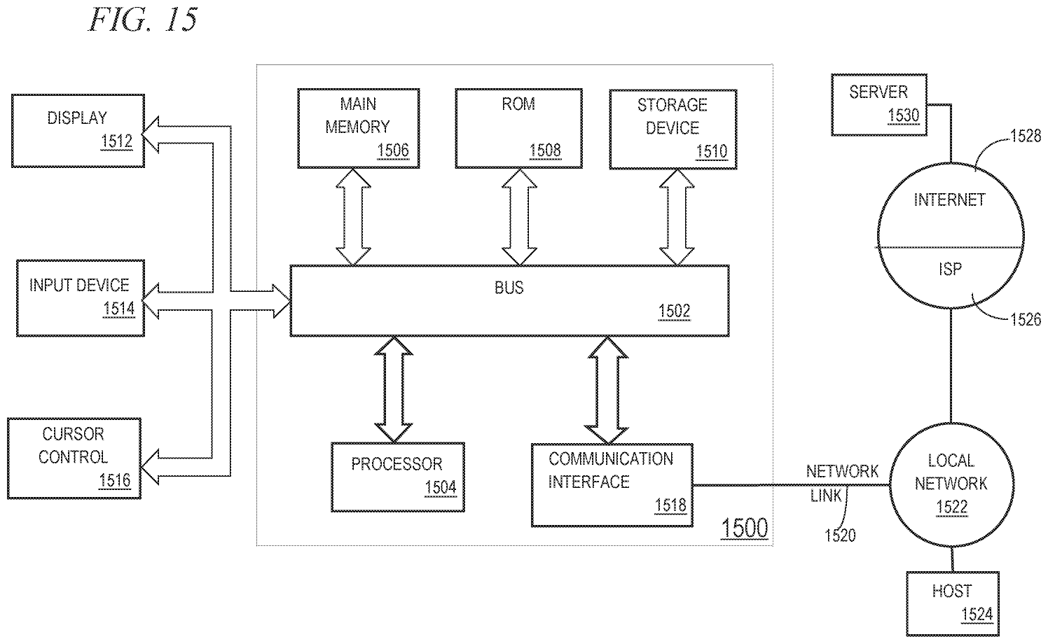

For example, FIG. 15 is a block diagram that illustrates a computer system 1500 upon which an embodiment of the invention may be implemented. Computer system 1500 includes a bus 1502 or other communication mechanism for communicating information, and a hardware processor 1504 coupled with bus 1502 for processing information. Hardware processor 1504 may be, for example, a general-purpose microprocessor.

Computer system 1500 also includes a main memory 1506, such as a random-access memory (RAM) or other dynamic storage device, coupled to bus 1502 for storing information and instructions to be executed by processor 1504. Main memory 1506 also may be used for storing temporary variables or other intermediate information during execution of instructions to be executed by processor 1504. Such instructions, when stored in non-transitory storage media accessible to processor 1504, render computer system 1500 into a special-purpose machine that is customized to perform the operations specified in the instructions.

Computer system 1500 further includes a read only memory (ROM) 1508 or other static storage device coupled to bus 1502 for storing static information and instructions for processor 1504. A storage device 1510, such as a magnetic disk, optical disk, or solid-state drive is provided and coupled to bus 1502 for storing information and instructions.

Computer system 1500 may be coupled via bus 1502 to a display 1512, such as a cathode ray tube (CRT), for displaying information to a computer user. An input device 1514, including alphanumeric and other keys, is coupled to bus 1502 for communicating information and command selections to processor 1504. Another type of user input device is cursor control 1516, such as a mouse, a trackball, or cursor direction keys for communicating direction information and command selections to processor 1504 and for controlling cursor movement on display 1512. This input device typically has two degrees of freedom in two axes, a first axis (e.g., x) and a second axis (e.g., y), that allows the device to specify positions in a plane.

Computer system 1500 may implement the techniques described herein using customized hard-wired logic, one or more ASICs or FPGAs, firmware and/or program logic which in combination with the computer system causes or programs computer system 1500 to be a special-purpose machine. According to one embodiment, the techniques herein are performed by computer system 1500 in response to processor 1504 executing one or more sequences of one or more instructions contained in main memory 1506. Such instructions may be read into main memory 1506 from another storage medium, such as storage device 1510. Execution of the sequences of instructions contained in main memory 1506 causes processor 1504 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage device 1510. Volatile media includes dynamic memory, such as main memory 1506. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 1502. Transmission media can also take the form of acoustic or light waves, such as those generated during radio-wave and infra-red data communications.

Various forms of media may be involved in carrying one or more sequences of one or more instructions to processor 1504 for execution. For example, the instructions may initially be carried on a magnetic disk or solid-state drive of a remote computer. The remote computer can load the instructions into its dynamic memory and send the instructions over a telephone line using a modem. A modem local to computer system 1500 can receive the data on the telephone line and use an infra-red transmitter to convert the data to an infra-red signal. An infra-red detector can receive the data carried in the infra-red signal and appropriate circuitry can place the data on bus 1502. Bus 1502 carries the data to main memory 1506, from which processor 1504 retrieves and executes the instructions. The instructions received by main memory 1506 may optionally be stored on storage device 1510 either before or after execution by processor 1504.

Computer system 1500 also includes a communication interface 1518 coupled to bus 1502. Communication interface 1518 provides a two-way data communication coupling to a network link 1520 that is connected to a local network 1522. For example, communication interface 1518 may be an integrated services digital network (ISDN) card, cable modem, satellite modem, or a modem to provide a data communication connection to a corresponding type of telephone line. As another example, communication interface 1518 may be a local area network (LAN) card to provide a data communication connection to a compatible LAN. Wireless links may also be implemented. In any such implementation, communication interface 1518 sends and receives electrical, electromagnetic, or optical signals that carry digital data streams representing various types of information.

Network link 1520 typically provides data communication through one or more networks to other data devices. For example, network link 1520 may provide a connection through local network 1522 to a host computer 1524 or to data equipment operated by an Internet Service Provider (ISP) 1526. ISP 1526 in turn provides data communication services through the world-wide packet data communication network now commonly referred to as the “Internet” 1528. Local network 1522 and Internet 1528 both use electrical, electromagnetic, or optical signals that carry digital data streams. The signals through the various networks and the signals on network link 1520 and through communication interface 1518, which carry the digital data to and from computer system 1500, are example forms of transmission media.

Computer system 1500 can send messages and receive data, including program code, through the network(s), network link 1520 and communication interface 1518. In the Internet example, a server 1530 might transmit a requested code for an application program through Internet 1528, ISP 1526, local network 1522 and communication interface 1518.

The received code may be executed by processor 1504 as it is received, and/or stored in storage device 1510, or other non-volatile storage for later execution.

### Software Overview

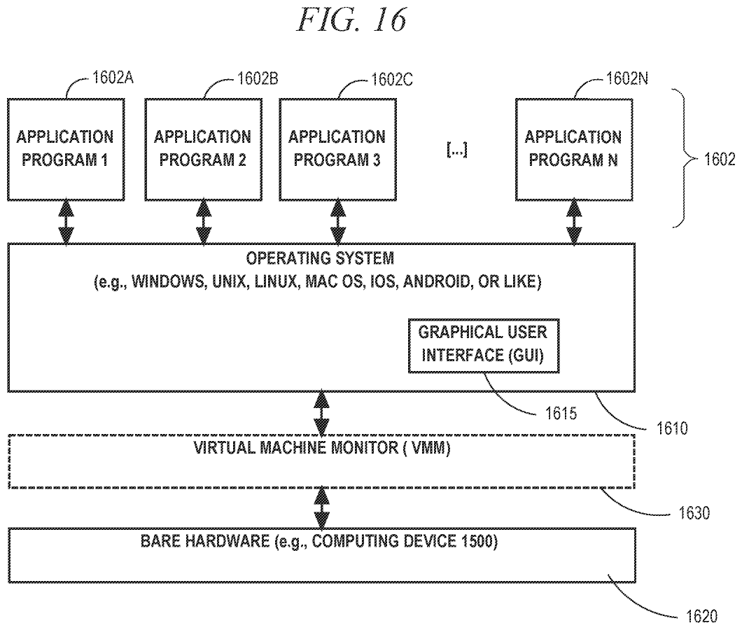

FIG. 16 is a block diagram of a basic software system 1600 that may be employed for controlling the operation of computer system 1500. Software system 1600 and its components, including their connections, relationships, and functions, is meant to be exemplary only, and not meant to limit implementations of the example embodiment(s). Other software systems suitable for implementing the example embodiment(s) may have different components, including components with different connections, relationships, and functions.

Software system 1600 is provided for directing the operation of computer system 1500. Software system 1600, which may be stored in system memory (RAM) 1506 and on fixed storage (e.g., hard disk or flash memory) 1510, includes a kernel or operating system (OS) 1610.

The OS 1610 manages low-level aspects of computer operation, including managing execution of processes, memory allocation, file input and output (I/O), and device I/O. One or more application programs, represented as 1602A, 1602B, 1602C . . . 1602N, may be “loaded” (e.g., transferred from fixed storage 1510 into memory 1506) for execution by the system 1600. The applications or other software intended for use on computer system 1500 may also be stored as a set of downloadable computer-executable instructions, for example, for downloading and installation from an Internet location (e.g., a Web server, an app store, or other online service).

Software system 1600 includes a graphical user interface (GUI) 1615, for receiving user commands and data in a graphical (e.g., “point-and-click” or “touch gesture”) fashion. These inputs, in turn, may be acted upon by the system 1600 in accordance with instructions from operating system 1610 and/or application(s) 1602. The GUI 1615 also serves to display the results of operation from the OS 1610 and application(s) 1602, whereupon the user may supply additional inputs or terminate the session (e.g., log off).

OS 1610 can execute directly on the bare hardware 1620 (e.g., processor(s) 1504) of computer system 1500. Alternatively, a hypervisor or virtual machine monitor (VMM) 1630 may be interposed between the bare hardware 1620 and the OS 1610. In this configuration, VMM 1630 acts as a software “cushion” or virtualization layer between the OS 1610 and the bare hardware 1620 of the computer system 1500.

VMM 1630 instantiates and runs one or more virtual machine instances (“guest machines”). Each guest machine comprises a “guest” operating system, such as OS 1610, and one or more applications, such as application(s) 1602, designed to execute on the guest operating system. The VMM 1630 presents the guest operating systems with a virtual operating platform and manages the execution of the guest operating systems.

In some instances, the VMM 1630 may allow a guest operating system to run as if it is running on the bare hardware 1620 of computer system 1500 directly. In these instances, the same version of the guest operating system configured to execute on the bare hardware 1620 directly may also execute on VMM 1630 without modification or reconfiguration. In other words, VMM 1630 may provide full hardware and CPU virtualization to a guest operating system in some instances.

In other instances, a guest operating system may be specially designed or configured to execute on VMM 1630 for efficiency. In these instances, the guest operating system is “aware” that it executes on a virtual machine monitor. In other words, VMM 1630 may provide para-virtualization to a guest operating system in some instances.

A computer system process comprises an allotment of hardware processor time, and an allotment of memory (physical and/or virtual), the allotment of memory being for storing instructions executed by the hardware processor, for storing data generated by the hardware processor executing the instructions, and/or for storing the hardware processor state (e.g., content of registers) between allotments of the hardware processor time when the computer system process is not running. Computer system processes run under the control of an operating system and may run under the control of other programs being executed on the computer system.

### Cloud Computing

The term “cloud computing” is generally used herein to describe a computing model which enables on-demand access to a shared pool of computing resources, such as computer networks, servers, software applications, and services, and which allows for rapid provisioning and release of resources with minimal management effort or service provider interaction.

A cloud computing environment (sometimes referred to as a cloud environment, or a cloud) can be implemented in a variety of different ways to best suit different requirements. For example, in a public cloud environment, the underlying computing infrastructure is owned by an organization that makes its cloud services available to other organizations or to the general public. In contrast, a private cloud environment is generally intended solely for use by, or within, a single organization. A community cloud is intended to be shared by several organizations within a community; while a hybrid cloud comprises two or more types of cloud (e.g., private, community, or public) that are bound together by data and application portability.

Generally, a cloud computing model enables some of those responsibilities which previously may have been provided by an organization's own information technology department, to instead be delivered as service layers within a cloud environment, for use by consumers (either within or external to the organization, according to the cloud's public/private nature). Depending on the particular implementation, the precise definition of components or features provided by or within each cloud service layer can vary, but common examples include: Software as a Service (SaaS), in which consumers use software applications that are running upon a cloud infrastructure, while a SaaS provider manages or controls the underlying cloud infrastructure and applications. Platform as a Service (PaaS), in which consumers can use software programming languages and development tools supported by a PaaS provider to develop, deploy, and otherwise control their own applications, while the PaaS provider manages or controls other aspects of the cloud environment (i.e., everything below the run-time execution environment). Infrastructure as a Service (IaaS), in which consumers can deploy and run arbitrary software applications, and/or provision processing, storage, networks, and other fundamental computing resources, while an IaaS provider manages or controls the underlying physical cloud infrastructure (i.e., everything below the operating system layer). Database as a Service (DBaaS) in which consumers use a database server or Database Management System that is running upon a cloud infrastructure, while a DbaaS provider manages or controls the underlying cloud infrastructure, applications, and servers, including one or more database servers.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A computer-implemented method comprising:
responsive to a rebalancing trigger condition, performing an incremental rebalancing operation to rebalance graph data across a cluster of machines running a graph processing engine, wherein:
the graph data comprises a set of chunks for one or more graphs distributed across the cluster of machines,
each chunk in the set of chunks comprises one or more graph data elements in the one or more graphs, and
performing the incremental rebalancing operation comprises:
selecting a chunk in a source machine in the cluster having a surplus of chunks;
selecting a target machine in the cluster having a deficit of chunks;
transferring the selected chunk from the source machine to the target machine; and
updating metadata in each machine in the cluster to reflect a location of the graph data elements in the selected chunk in the target machine,
wherein the method is performed by one or more computing devices.

2. The method of claim 1, wherein the rebalancing trigger condition comprises one of:
the graph processing engine being idle,
a command being received prior to execution of the command,
a command being on-hold for adding a machine to the cluster of machines,
a command being on-hold for removing a machine from the cluster of machines, or a safe-point during command execution.

3. The method of claim 1, wherein:
a given graph within the one or more graphs comprises a plurality of vertex tables from a vertex provider,
each of the plurality of vertex tables has one or more linked edge tables and at least one property array,
each property array in the at least one property array comprises a pointer to a physical array, and
the selected chunk comprises a given vertex table from the plurality of vertex tables, one or more edge tables linked to the given vertex table, and at least one property array of the given vertex table.

4. The method of claim 3, wherein transferring the selected chunk from the source machine to the target machine comprises:
initializing the given vertex table and the one or more linked edge tables on the target machine;
initializing the at least one property array with empty data on the target machine;
for each physical array, sending data of the physical array from the source machine to the target machine and per-property array data for the at least one property array referencing the physical array; and
updating each property array with a pointer to a corresponding physical array at the target machine.

5. The method of claim 4, wherein transferring the selected chunk from the source machine to the target machine further comprises applying one or more updates to the at least one property array at the target machine.

6. The method of claim 3, wherein:
the one or more graphs comprise a first graph and a second graph having equivalent tables that share a given physical array,
the selected chunk comprises one of the equivalent tables, and
transferring the selected chunk comprises transferring chunks for the equivalent tables from the first graph and the second graph in a single chunk transfer.

7. The method of claim 1, wherein:
the graph data includes a plurality of sets of equivalent chunks,
each set of equivalent chunks comprises a set of chunks that have vertex tables originating from a same history of graphs in a same vertex provider, and
performing the incremental rebalancing operation comprises:
determining a batch size specifying a number of chunks to be transferred in a batch of the incremental rebalancing operation;
selecting a set of equivalent chunks from available graphs within the one or more graphs to be prioritized for rebalancing, wherein the selected chunk is selected from the selected set of equivalent chunks; and
adding an entry in a batch data structure, the entry identifying the selected set of equivalent chunks, the selected chunk, the source machine, and the target machine.

8. The method of claim 7, wherein:
performing the incremental rebalancing operation further comprises updating temporary chunk metadata to reflect the selected set of equivalent chunks, the selected chunk, the source machine, and the target machine, and
a next chunk for rebalancing is selected based on the temporary chunk metadata.

9. The method of claim 7, wherein selecting the set of equivalent chunks comprises:
for each given set of equivalent chunks:
determining, for each given machine in the cluster of machines, a difference between a current number of chunks from the given set of equivalent chunks in the given machine and a target number of chunks for the given machine; and
determining a rank value using a function of the differences for the machines in the cluster; and
selecting a set of equivalent chunks having a highest base rank value.

10. The method of claim 9, wherein the target number of chunks for each machine is determined based on a weight value for each machine in the cluster of machines.

11. The method of claim 10, further comprising setting a weight value of a machine to be removed from the cluster to zero.

12. The method of claim 9, wherein the target number of chunks for each machine is determined based on a weight value for each graph on each machine.

13. The method of claim 9, wherein the function of the differences for the machines in the cluster comprises one of a sum of absolute values of the differences or a sum of squares of the differences.

14. The method of claim 1, wherein performing the incremental rebalancing operation comprises transferring a second chunk from a second source machine to a second target machine in parallel with transferring the selected chunk from the source machine to the target machine.

15. The method of claim 1, wherein transferring the selected chunk comprises transferring the selected chunk using one of message passing or storing the selected chunk in a shared filesystem or cloud object store.

16. The method of claim 1, further comprising receiving a command to perform a graph processing operation, wherein the command includes a rebalancing call to perform the incremental rebalancing operation.

17. The method of claim 1, wherein the selected chunk is selected based on a determination that transferring the selected chunk decreases imbalance of the graph data across a cluster of machines.

18. The method of claim 1, further comprising interrupting the incremental rebalancing operation in response to receiving a command that accesses the graph data of the one or more graphs.

19. One or more non-transitory storage media storing instructions which, when executed by one or more computing devices, cause performance of a method comprising:
responsive to a rebalancing trigger condition, performing an incremental rebalancing operation to rebalance graph data across a cluster of machines running a graph processing engine, wherein:
the graph data comprises a set of chunks for one or more graphs distributed across the cluster of machines,
each chunk in the set of chunks comprises one or more graph data elements in the one or more graphs, and
performing the incremental rebalancing operation comprises:
selecting a chunk in a source machine in the cluster having a surplus of chunks;
selecting a target machine in the cluster having a deficit of chunks;
transferring the selected chunk from the source machine to the target machine; and
updating metadata in each machine in the cluster to reflect a location of the graph data elements in the selected chunk in the target machine.

20. The one or more non-transitory storage media of claim 19, wherein the rebalancing trigger condition comprises one of:
the graph processing engine being idle,
a command being received prior to execution of the command,
a command being on-hold for adding a machine to the cluster of machines,
a command being on-hold for removing a machine from the cluster of machines, or a safe-point during command execution.
